(19) United States
(12) Patent Application Publication
(10) Pub. No.: US 2015/0364120 A1
(43) Pub. Date: Dec. 17, 2015

(54) VARIABLE NOISE DAMPENING FOR DRUMS AND CYMBALS

(71) Applicant: Rachiele Holdings, LLC, Apopka, FL (US)

(72) Inventor: Dino Rachiele, Apopka, FL (US)

(21) Appl. No.: 14/739,156

(22) Filed: Jun. 15, 2015

Related U.S. Application Data
(60) Provisional application No. 62/011,708, filed on Jun. 13, 2014.

(51) Int. Cl. G10D 13/02; B32B 15/06; B32B 25/14; B32B 25/18; B32B 25/16; G10D 13/06; B32B 15/20

(52) U.S. Cl. CPC G10D 13/022; G10D 13/06; B32B 15/06; B32B 15/20; B32B 25/18; B32B 25/16; B32B 25/14; B32B 2405/00; B32B 2307/10

(57) ABSTRACT

The composition and use of a semi-rigid aluminum layered a rubberized layer with a self-adhesive for use on drums and cymbals to damp vibrations and thus dampen the sound emitted from the drums or cymbals. The composition may further include polymeric layer and optionally polyester top label. Position and number of the compositions disposed on the drum or cymbal can provides the ability to adjust the noise level.

### CROSS-REFERENCE TO RELATED APPLICATIONS

This nonprovisional application is a continuation of and claims priority to U.S. Provisional Application No. 62/011,708, entitled “Variable Noise Dampening for Drums and Cymbals”, filed June 13^{th}, 2014 by the same inventor, the entirety of which is incorporated herein by reference.

### BACKGROUND OF THE INVENTION

1. Field of the Invention

This invention relates, generally, to sound-enhancing accessories for drums and cymbals. More specifically, it relates to compositions and methodologies for dampening or normalizing the excess noise or sound emitted from drums and/or cymbals.

2. Brief Description of the Prior Art

In the art of drums and cymbals, there is a significant problem of excess volume stemming from the drums and cymbals in certain venues and/or from certain brands/types of drums and cymbals. For example, churches and smaller venues require a lower drum volume that, currently, has not been addressed effectively. Further, home practice with an acoustic drum set is currently difficult as well.

The art has attempted to dampen the noise from drums and cymbals. Products, such as Plexiglas shields, gel pads, duct tape and other options are currently being used with limited success. The only solution to significantly reduce the volume is a complete rubber cover for each drum. At that point, though, the drum will not “play” or “feel” like a real drum, so the drummer will not have the same playing action as the acoustic set without the cover. This makes it difficult for the drummer to acquire “muscle” memory, as the reaction is completely different using a full pad versus no pad. The current art provides the options for virtually no sound or full volume, i.e., no medium ground for simply reducing or eliminating the excess noise while maintaining the sound quality and experience of striking the drums or cymbals.

Musicians have also attempted to decrease or dampen noise levels by using damping gel pads. However, damping gel pads collect lint, hair and dust. They dry out and fall off the drums after a period of time. They cannot be used on cymbals, as they will not properly adhere to cymbals. Further, several damping gel pads typically must be used on a single drum in order to achieve a fraction of the sound deadening desired.

Other known methods for dampening particular types of drums is to place a blank or pillow inside of a bass drum, cutting a hole in the back drum to reduce resonance, adhering a cloth strip against the inside of a batter head, placing a drum ring on top of a snare or tom drum, adhering duct tape on a batter head, and using specialized drum sticks that intend to lower the drum volume. However, each of these methodologies has its drawbacks, such as inapplicability to cymbals, inapplicability to a variety of types of drums, physical damage to the drum, ineffectiveness, inefficiency, reduced sound quality (particularly from cymbals), etc.

Accordingly, what is needed is an improved mechanism of dampening the excess noise emitted by drums and cymbals, in particular. However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date; publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for an improved apparatus and methodology for damping vibrations of a struck drum or cymbal is now met by a new, useful, and nonobvious invention.

In an embodiment, the current invention is a composition for damping vibrations experienced by a drum or cymbal when a user thereof strikes the drum or cymbal (e.g., via a drumstick). The composition includes a first layer formed of a flexible rubberized material (e.g., non-curing butylene rubber, neoprene, ethylene propylene diene terpolymer, styrene-butadiene rubber, and a combination thereof). An adhesive material is disposed on the outer surface of the first layer for contacting and adhering to a surface of the drum or cymbal. The outer surface of the first layer has dimensions that are smaller than the dimensions of the drum or cymbal, so that the user can contact the drum or cymbal without contacting the composition. The composition further includes a second layer formed of a semi-rigid metallic material (e.g., semi-rigid aluminum). The inner surface of the second layer is secured to the inner surface of the first layer. The outer surface of the second layer is then exposed to the external environment. As such, the second layer itself does not contact the drum or cymbal.

Optionally, the composition may include a third layer formed of a polymer on top of the metallic layer. The composition may further include a fourth layer formed of a top polyester layer.

In a separate embodiment, the current invention is a method of damping vibrations experienced by a drum upon a user thereof striking the drum (e.g., via a drum stick). A layered composition is positioned on a top or bottom surface of the drum. The composition has a structure substantially similar to that described in the preceding paragraphs. Damping of the vibrations can be adjusted according to the needs of the user, for example by changing the number of compositions positioned on the drum adding a composition results in greater damping, removing a composition results in lesser damping). Due to the structure of the second layer, visible information (e.g., logos, text, graphics, etc.) may be printed directly onto the outer surface of the second layer.

In a separate embodiment, the current invention is a method of damping vibrations experienced by a cymbal upon a user thereof striking the cymbal (e.g., via a drum stick). A layered composition is positioned on a top or bottom surface of the cymbal. The composition has a structure substantially similar to that described in the preceding paragraphs. Due to the structure of the second layer, visible information (e.g., logos, text, graphics, etc.) may be printed directly onto the outer surface of the second layer.

Damping of the vibrations can be adjusted according to the needs of the user, for example by changing the number of compositions positioned on the cymbal (i.e., adding a composition results in greater damping, removing a composition results in lesser damping). Alternatively, repositioning a composition closer to an outer edge/boundary of the cymbal results in greater damping; repositioning a composition closer to a central bell of the cymbal results in lesser damping.

These and other important Objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a filler understanding of the invention, reference should be made to the following detailed description, taken in connection with the accompanying drawings, in which:

FIG. 1A is a schematic of a drum with a dampening composition attached thereto on the bottom of the drum.

FIG. 1B is a schematic of a drum with a dampening composition attached thereto on the top of the drum.

FIG. 2 is a schematic of a cymbal with a circular dampening composition attached thereto.

FIG. 3 is a schematic of a cymbal with a dampening composition attached thereto in order from point A (least dampening) to point F (most dampening).

FIG. 4 is a schematic of a cross-section of a dampening composition according to an embodiment of the current invention.

FIG. 5A depicts harmonics without use of any dampening material.

FIG. 5B depicts harmonics with use of prior art dampening material.

FIG. 5C depicts harmonics using a dampening composition according to an embodiment of the current invention.

FIG. 6 is a schematic of a cross-section of a dampening composition according to an alternate embodiment of the current invention.

### DETAILED DESCRIPTION OF THE PREFERRED EMBODIMENT

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

In an embodiment, the current invention is a layered composition (e.g., formed of V-MAX CLD Vibration Damping Material)—and method of use thereof—that can dampen the sound or noise emitted by a drum or cymbal to a tolerable and more effective level, such as for “in-home” use, without disturbing the playing surface of the drum head and without damaging or covering up any portion of the drum or cymbal. This is accomplished by damping the vibration of the drum head or cymbal upon striking, thereby gating the drum. This preserves the user's ability for muscle memory acquisition for both drums and cymbals.

It has been tested and seen that certain embodiments of the current invention allow adjustment in volume from a maximum volume to a volume of less than half of the maximum emitted by the drum or cymbal. In certain embodiments, the composition includes sufficient adhesive to be secured to cymbals indefinitely. The adhesive also allows for reapplication and movement to different areas of the cymbal or drum to effectuate different levels of vibration damping (i.e., different volume and tone levels). As such, the composition permits for incremental lowering of the volume of the underlying drum or cymbal.

### Drums

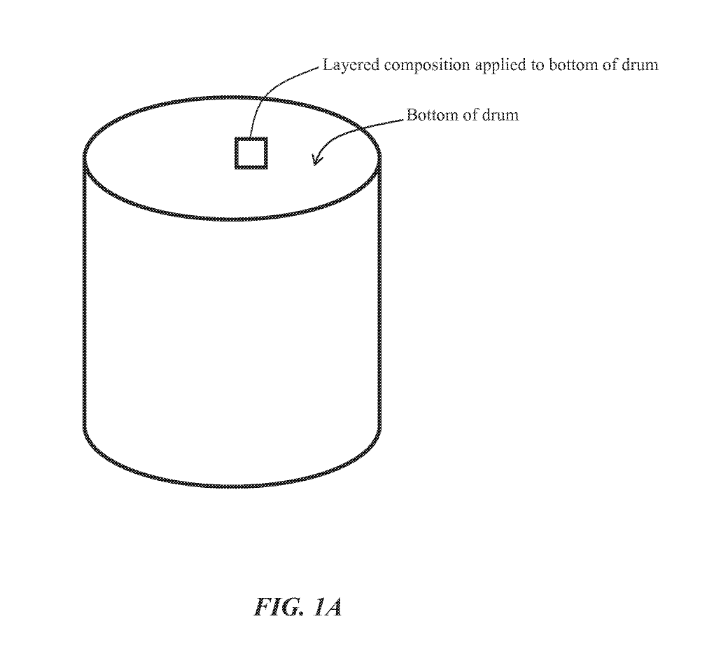

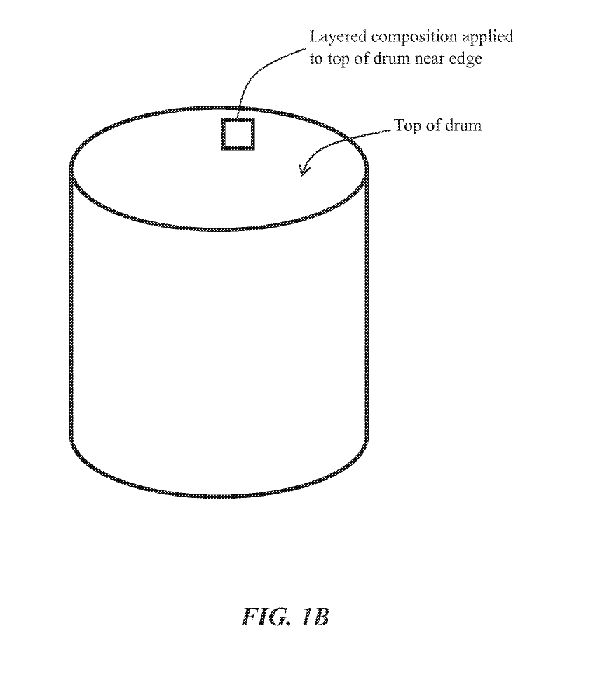

Variable or incremental volume control can be achieved on drums by adhering a layered composition onto the top or the bottom of the drum, as seen in FIGS. 1A-1B, or even by adhering a plurality of layered compositions onto the top and/or bottom of the drum. As the number of layered compositions increases on the drum, the sound level of the drum will decrease, as there is a greater amount of vibration damping. In other words, the layered compositions of the current invention, when used on drums, dampen the unwanted “booming” sounds and over resonance control.

In an embodiment, the layered composition is removable and movable (e.g., to another drum, cymbal, etc.). It is contemplated herein that each layered composition can have any dimension or shape. In a particular use, a 1¼″ layered composition can be adhered to the top of a drum near an edge of the drum (FIG. 1B), and a larger layered composition can be adhered to the bottom of the drum in the middle of the drum (FIG. 1A). This allows a user to fully customize the vibration damping or sound level outputted.

### Cymbals

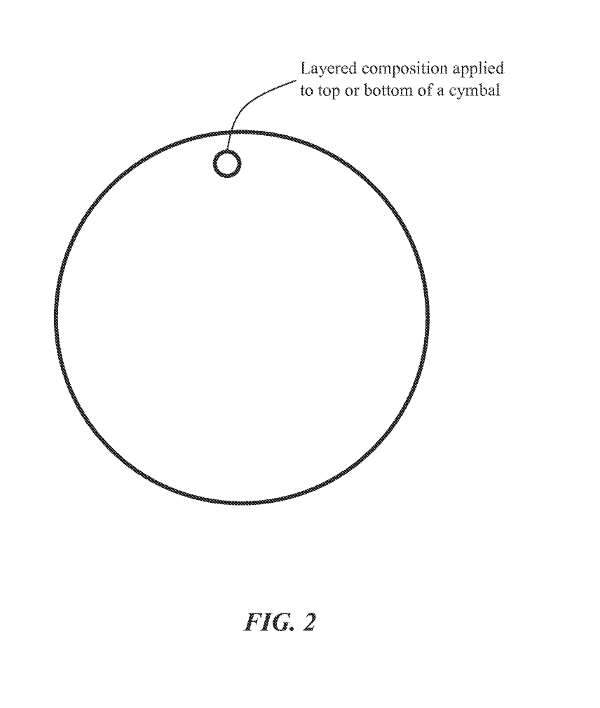

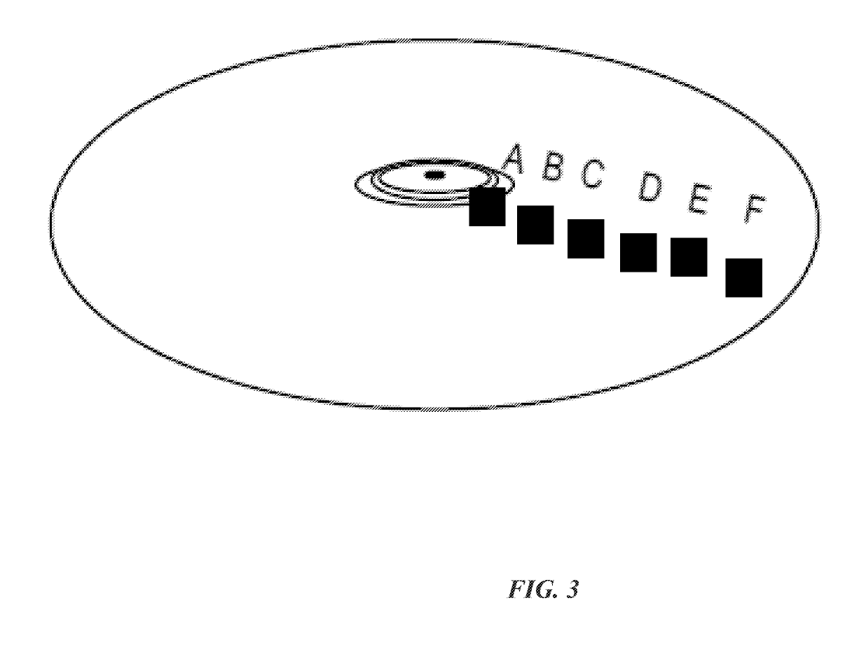

In certain embodiments, the current invention provides volume level control to drums and more significantly, to cymbals. Variable or incremental volume control can be achieved on cymbals by placing the layered composition(s) on the cymbal, as seen in FIG. 2, in different locations. The volume of the sound and the proximity of the layered composition to the center of the bell of the symbol have a direct relationship; in other words, the amount of vibration damping and the proximity of the layered composition to the center of the bell of the symbol have an indirect relationship. This means that the closer the layered composition is to the center or bell of the cymbal, the higher the volume will be, and the less amount of vibration damping will be experienced, as seen in FIG. 3. In turn, as the layered composition is positioned closer to the outside of the cymbal (i.e., further from the bell of the cymbal), the volume of the sound will reduce, as a higher amount of vibration damping is experienced.

In FIG. 3, point A denotes the highest volume (lowest vibration damping) that would be achieved, and point F denotes the lowest volume (highest vibration damping) that would be achieved. As such, positioning of a layered composition (or even multiple layered compositions) can be changed to achieve the sound level desired, even between or within songs in a set, while remaining secure to the cymbal in each position. This is a significant advantage over the conventional art, such as MOONGEL dampening pads, which is incapable of adhering to the bottom of cymbals, as opposed to the current invention, which is capable of adhering to the top or bottom of cymbals and drums and capable of being removed and reattached in different areas for different sound levels and tones, as discussed.

### Composition

### Example 1

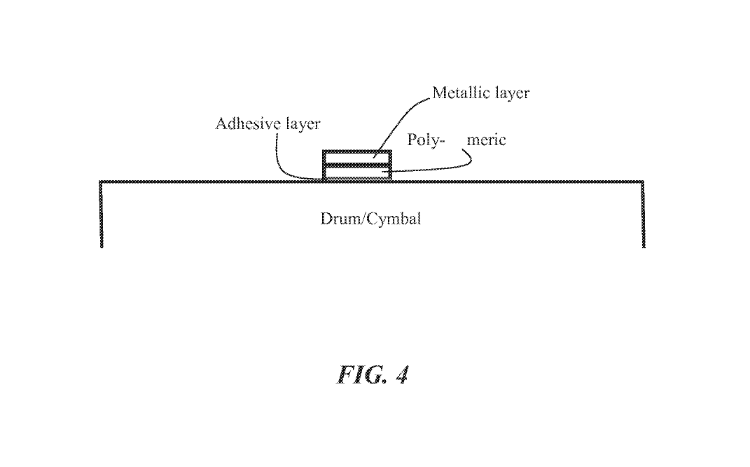

In an embodiment, as seen in FIG. 4 (layers are not drawn to scale), the layered composition includes a first layer of typically flexible rubber (e.g., butylene rubber or other polymer) with a self-adhesive attached thereto for contacting and adhering to the drum or cymbal. The layered composition further includes a second layer of metal, for example semi-rigid aluminum, that does not and cannot contact the drum or cymbal. In an embodiment, the facial dimensions of the rubber layer and the metallic layer are similar. When these layers are combined, they unexpectedly provide sheer strength to limit vibration of the drum or cymbal, thus affecting sound volume and the length of the resonance.

In an embodiment, the current invention is a unique combination of vibration-damping, sound-deadening materials using a flexible layer (e.g., rubber, butylene rubber, other polymer, etc.) as well as a semi-rigid aluminum layer to damp the vibrations upon striking, thereby dampening the sound emitted by drum and/or cymbal. Unlike other types of vibration damping material used in the art of drums and cymbals, the current invention was contemplated to utilize sheer force to control vibration and dampen the resonating sound of the drum and cymbal. A key to this particular embodiment of the invention is the semi-rigid aluminum layer, whereas the conventional art relies on a softer material that allows vibration to occur. Aluminum combined with the flexible rubber layer does not vibrate, and it significantly diminishes and controls the vibration.

The resulting noise dampening and the level of dampening was unexpectedly found. For example, a square-shaped layered composition with a length of about 1¼ inches was found to be able to achieve over three (3) times the sound deadening of the soft, rubbery gel pads of the conventional art, which attract dust and fuzz. Further, the current invention was capable of achieving this without negatively affected the sound or tone emitted from the drum or cymbal.

The side of the metallic layer opposite from the side that is adhered to the polymeric layer can be used for printing thereon, for example for logos, brands, and other prints. Print on the metallic layer is possible because the top layer is semi-rigid or rigid. The conventional art is incapable of achieving this because their top layers are typically formed of gel or felt. Alternatively, another distinct layer (e.g., formed of paper) can be positioned on top of the metallic layer and can be used as a color printed layer. This is facilitated by the layered composition being substantially flat.

It is contemplated herein that the composition can have any shape or size as desired by a user thereof. For example, the composition can be square or circular and 1¼ inches in length/diameter. The individual layers can have any thickness desired by a user thereof. For example, the metallic layer can be about four (4) millimeters thick.

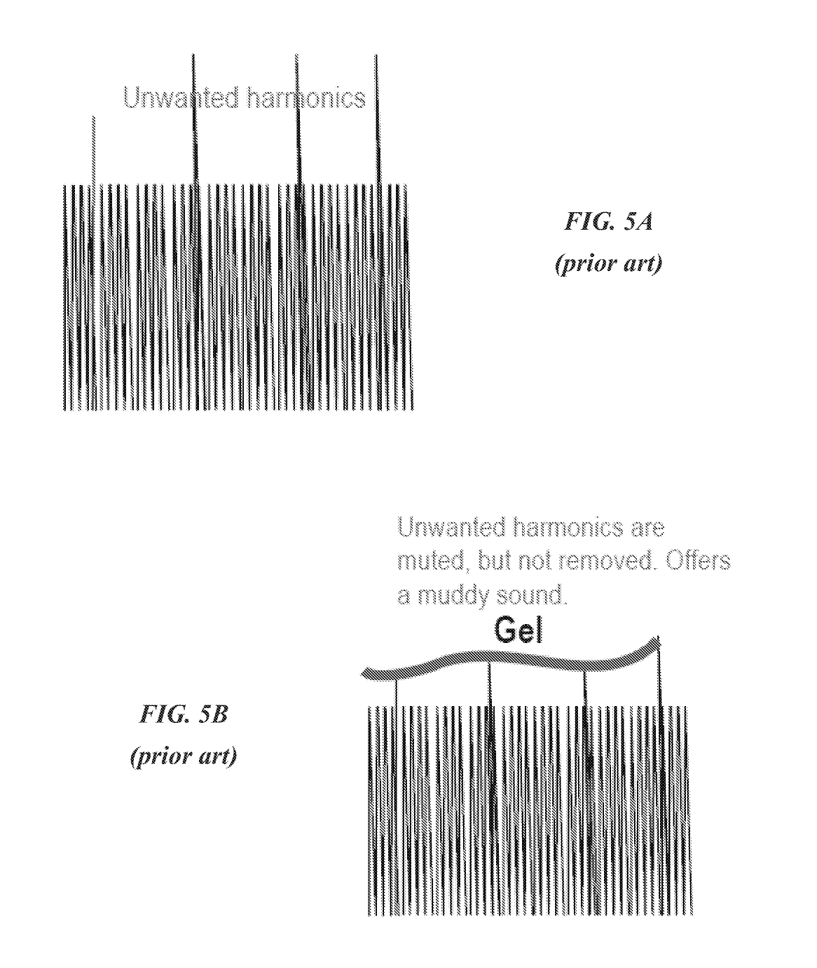

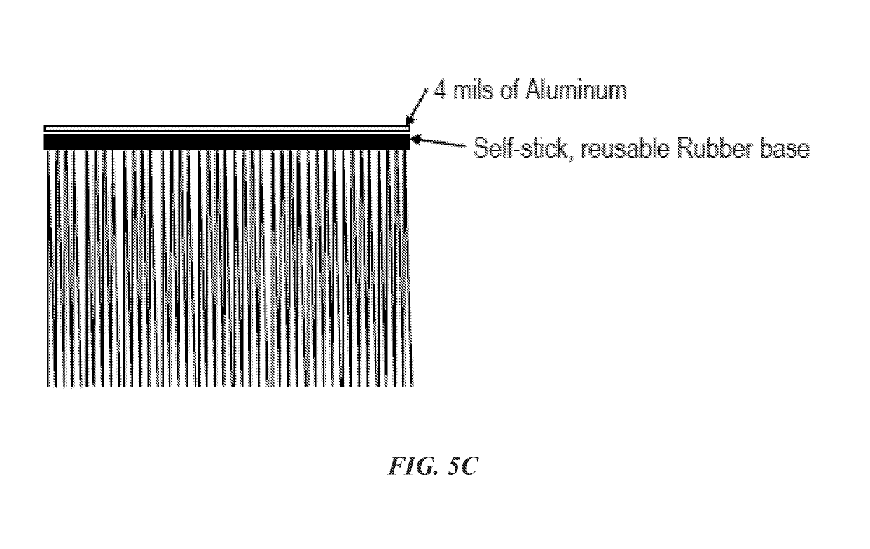

It is contemplated herein that the metallic (e.g., aluminum, semi-rigid aluminum) layer is a critical component/layer of the current invention. FIG. 5A shows the acoustics when there is no dampening layer positioned on the drum or cymbal. This leads to unmuted unwanted harmonics. FIG. 5B shows the acoustics when a gel dampening composition, according to the prior art, is positioned on the drum or cymbal. This gel dampening composition mutes the unwanted harmonics but does not remove them at a consistent level, due to the malleability of the composition and the harmonics hitting the composition at varying depths. This leads to a muddy sound. FIG. 5C shows the current invention with the metallic (e.g., aluminum) layer. The harmonics in this case mutes and removes the unwanted harmonics at a consistent level, due to the rigidity of the metallic layer and the harmonics hitting the composition at a consistent depth. This leads to the current composition shearing off the unwanted harmonic tones, leaving a crisp, authentic, clean tone of the drum or cymbal. This is important for maintaining exceptional sound quality when attempting to damp the vibrations and remove the unwanted harmonics.

### Example 2

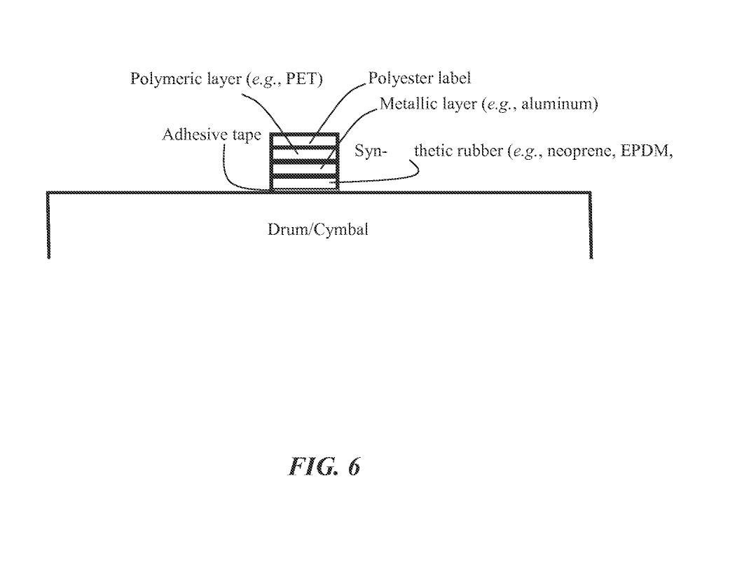

In an alternative embodiment, as seen in FIG. 6 (layers are not drawn to scale), the current invention is a layered composition including four (4) distinct layers. The first layer (i.e., the layer adhered to the underlying drum or cymbal) can be formed of a synthetic rubber—for example including, but not limited to, neoprene, ethylene propylene diene terpolymer (EPDM)/styrene-butadiene rubber (SBR), or a combination thereof—with a repositionable adhesive tape (e.g., 3M®).

The second layer is formed of metallic substance, such as 4 mm of aluminum.

The third layer is formed of a polymer, such as a polyester, specifically polyethylene terephthalate (PET).

The layered composition may include a label directly applied to the third layer. Alternatively, the fourth (i.e., top) layer can be formed of a polyester label for printing.

### Experiments

A layered composition, according to an embodiment of the current invention, was compared against a RTOM MOONGEL percussion dampening gel for effectiveness in dampening the sound of a cymbal. The layered composition included a flexible layer of butylene rubber and a semi-rigid layer of aluminum, where the two layers are adhered to one another on one side. An adhesive is included on the opposite side of the butylene rubber layer as well, and the butylene rubber layer is intended to be adhered to the cymbal. The MOONGEL pads are commercially available and formed of a soft, non-toxic gel.

In procedure, a metal nut was dropped onto a cymbal from a vertically- and horizontally-fixed position. The layered composition (invention) and MOONGEL pad (conventional) were placed at different horizontal positions—center (near the bell) of the cymbal, midway outward on the cymbal, and an outer position of the cymbal—when the metal nut was dropped onto the cymbal. To keep factors constant, the distance between the cymbal and the height at which the metal nut was dropped remained constant.

The results were seen as follows:

TABLE 1
Comparison of sound dampening between the conventional
art and the current invention.

| Position of Dampening | Type of Dampening | |
|---|---|---|
| Material on Cymbal | Material | Decibel Level (dB) |
| Baseline - no dampening | N/A | 98 |
| material used | | |
| Center (Bell) | Conventional | 96 |
| | Invention | 81 |
| Midway | Conventional | 94 |
| | Invention | 77 |
| Outer | Conventional | 84 |
| | Invention | 68 |

As can be seen in Table 1, when the dampening material was positioned at the center, the conventional art was seen to be about 2.82 times louder than the current invention. When the dampening material was positioned at a midway point on the cymbal, the conventional art was seen to be about 3.25 times louder than the current invention. When the dampening material was positioned at an outer position on the cymbal, the conventional art was seen to be about 3.03 times louder than the current invention. Acousticians note that a change of 10 decibels is sensed as a doubling in volume (loudness). The following equations were used to determine the factor by which the current invention dampened sound over the conventional art:

$$\begin{matrix}Eq . 1 \text{:} ratio or factor z - loudness ( volume of the sound ) \\ Eq . 2 \text{:} level cha nge Δ {L}_{loud} - psychoacoustics quantity ( perceived ) \\ z = {10}^{\frac{Δ L}{33.22}} = {2}^{\frac{Δ L}{10}} & Eq . 1 \\ Δ L = 10 \cdot {log}_{2} z = 33.22 \cdot log z & Eq . 2\end{matrix}$$

The effectiveness and benefits of the current invention were quite unexpected in light of the sound dampening of the conventional art being known. It is desired, under normal conditions or conditions where even lower volume is wanted, for the sound levels of a cymbal to be at the sound level observed with the current invention while retaining quality tone, rather than the more ineffective levels sound dampening of the conventional art.

### GLOSSARY OF CLAIM TERMS

Damping: This term is used herein to refer to the reduction or suppression of vibrations, thus reducing excess noise caused by the vibrations.

Dimensions: This term is used herein to refer to the measure of spatial extent of a structure in given directions

External environment: This term is used herein to refer to an area surrounding a closed system, such as a layered composition and drum/cymbal.

Vibrations: This term is used herein to refer to oscillations of a drum head or cymbal caused by a user thereof striking the drum head or cymbal.

Visible information: This term is used herein to refer to printed matter on the surface of a structure. Examples include, but are not limited to, logos, text, symbols, and graphics.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A composition for damping vibrations experienced by a drum or a cymbal upon a user thereof striking said drum or said cymbal:
a first layer formed of a flexible rubberized material, said first layer having a bottom surface and a top surface;
an adhesive material disposed on said bottom surface of said first layer for contacting and adhering to a surface of said drum or said cymbal,
said bottom surface of said first layer having a set of dimensions that are smaller than a set of dimensions of said drum or said cymbal, such that said user thereof can contact said drum or said cymbal without contacting said composition;
a second layer formed of a metallic material, said second layer having a bottom surface and a top surface,
said bottom surface of said second layer secured to said top surface of said first layer,
wherein said second layer does not contact said drum or said cymbal.

2. A composition for dampening noise emitted by a drum or a cymbal as in claim 1, further comprising:
said metallic material being semi-rigid aluminum.

3. A composition for dampening noise emitted by a drum or a cymbal as in claim 2, further comprising:
said flexible rubberized material being formed of a material selecting from the group consisting of non-curing butylene rubber, neoprene, ethylene propylene diene terpolymer, styrene-butadiene rubber, and a combination thereof.

4. A composition for dampening noise emitted by a drum or a cymbal as in claim 1, further comprising:
a third layer formed of a polymer, said third layer having a bottom surface and a top surface, said bottom surface of said third layer being secured to said top surface said second layer.

5. A composition for dampening noise emitted by a drum or a cymbal as in claim 4, further comprising:
a fourth layer being a top polyester label, said fourth layer having a bottom surface and a top surface, said bottom surface of said fourth layer being secured to said top surface said third layer.

6. A method of damping vibrations of a drum by a first amount, said vibrations experienced by said drum upon a user thereof striking said drum comprising:
positioning a layered composition on a top or bottom surface of said drum, wherein said layered composition comprises:
a first layer formed of a flexible rubberized material, said first layer having a bottom surface and a top surface;
an adhesive material disposed on said bottom surface of said first layer for contacting and adhering to a surface of said drum,
said bottom surface having a set of dimensions that are smaller than a set of dimensions of said drum, such that said user thereof can contact said drum without contacting said composition;
a second layer formed of a metallic material, said second layer having a bottom surface and a top surface,
said bottom surface of said second layer secured to said top surface of said first layer,
wherein said second layer does not contact said drum,
wherein damping of said vibrations can be adjusted according to needs of said user.

7. A method of damping vibrations of a drum as in claim 6, further comprising:
printing visible information directly on said top surface of said second layer.

8. A method of damping vibrations of a drum as in claim 6, further comprising:
damping said vibrations by a second amount greater than said first amount by positioning an additional layered composition on said top or bottom surface of said drum, said additional layered composition having a substantially similar structure to said layered composition.

9. A method of damping vibrations of a drum as in claim 6, further comprising:
said metallic material being semi-rigid aluminum.

10. A method of damping vibrations of a drum as in claim 9, further comprising:
said flexible rubberized material being formed of a material selecting from the group consisting of non-curing butylene rubber, neoprene, ethylene propylene diene terpolymer, styrene-butadiene rubber, and a combination thereof.

11. A method of damping vibrations of a drum as in claim 6, further comprising:
a third layer formed of a polymer, said third layer having a bottom surface and a top surface, said bottom surface of said third layer being secured to said top surface said second layer.
a fourth layer being a top polyester label, said fourth layer having a bottom surface and a top surface, said bottom surface of said fourth layer being secured to said top surface said third layer.

12. A method of damping vibrations of a cymbal by a first amount, said vibrations experienced by said cymbal upon a user thereof striking said cymbal, comprising:
positioning a layered composition on a top or bottom surface of said cymbal at a first location, wherein said layered composition comprises:
a first layer formed of a flexible rubberized material, said first layer having a bottom surface and a top surface;
an adhesive material disposed on said bottom surface of said first layer for contacting and adhering to a surface of said cymbal,
said bottom surface having a set of dimensions that are smaller than a set of dimensions of said cymbal, such that said user thereof can contact said cymbal without contacting said composition;
a second layer formed of a metallic material, said second layer having a bottom surface and a top surface,
said bottom surface of said second layer secured to said top surface of said first layer,
wherein said second layer does not contact said cymbal,
wherein damping of said vibrations can be adjusted according to needs of said user.

13. A method of damping vibrations experienced by a cymbal as in claim 12, further comprising:
damping said vibrations by a second amount greater than said first amount by repositioning said layered composition to a second location closer to an outer boundary of said cymbal than said first location.

14. A method of damping vibrations experienced by a cymbal as in claim 12, further comprising:
damping said vibrations by a second amount lesser than said first amount by repositioning said layered composition to a second location closer to a bell of said cymbal than said first location.

15. A method of damping vibrations experienced by a cymbal as in claim 12, further comprising:
damping said vibrations by a second amount greater than said first amount by positioning an additional layered composition on said top or bottom surface of said cymbal, said additional layered composition having a substantially similar structure to said layered composition.

16. A method of damping vibrations experienced by a cymbal as in claim 12, further comprising:
printing visible information directly on said top surface of said second layer.

17. A method of damping vibrations experienced by a cymbal as in claim 12, further comprising:
said metallic material being semi-rigid aluminum.

18. A method of damping vibrations experienced by a cymbal as in claim 17, further comprising:
said flexible rubberized material being formed of a material selecting from the group consisting of non-curing butylene rubber, neoprene, ethylene propylene diene terpolymer, styrene-butadiene rubber, and a combination thereof.

19. A method of damping vibrations experienced by a cymbal as in claim 12, further comprising:
a third layer formed of a polymer, said third layer having a bottom surface and a top surface, said bottom surface of said third layer being secured to said top surface said second layer.

20. A method of damping vibrations experienced by a cymbal as in claim 19, further comprising:
a fourth layer being a top polyester label, said fourth layer having a bottom surface and a top surface, said bottom surface of said fourth layer being secured to said top surface said third layer.
